(19) United States
(12) Patent Application Publication
(10) Pub. No.: US 2003/0086109 A1
(43) Pub. Date: May 8, 2003

(54) Printer help apparatus and method

(76) Inventor: Catherine Jo Fitch, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/010,462

(22) Filed: Nov. 8, 2001

(51) Int. Cl. B41F 1/00; G06F 15/00

(52) U.S. Cl. 358/1.14; 358/1.15

(57) ABSTRACT

A printer help apparatus and method includes a printer and a supplemental audio/video control, conformed to display audio/visual information concerning the functioning of the printer, connected to the printer at the printer location. In a further aspect of the invention, the supplemental audio/visual control is conformed to display prerecorded videos, to receive dynamic content for display and to conduct video conferences. In a further aspect of the invention, the printer is connected to a network and at least one computer.

### FIELD OF THE INVENTION

This invention relates to a printer help apparatus and method. In particular, the invention relates to a printer help apparatus and method wherein a supplemental audio/video control device is conformed to display audio/visual information concerning the functioning of the printer connected to the printer at the printer location.

### BACKGROUND OF THE INVENTION

A typical business office includes a computer system of networked computers and printers. In general, there are more computers than printers so that the printers are remote from most of the computers to which they are networked. These “distributed” printers are very capable business machines. They are machines, however, and they are not perfect. That is to say, the printers are subject to functioning errors.

When a functioning problem does occur with a printer, a variety of prior art solutions are available to attempt to assist a user in correcting the printer problem. The most common prior art solution is a written printer manual which attempts to describe the most common forms of printer functioning problems in a way that the lay person can read and understand. Nowadays, these written printer manuals are also found in electronic form for use on a user's computer. Once again these electronic forms of manuals are text based and, in the best case, have limited pictures. Similarly, the Internet is a source of help to users facing printer problems. This assistance is directed to the user at the computer desktop, far removed typically from the malfunctioning printer, and is primarily text based information. A further difficulty with this type of printer help is the fact that the applicability of the information sent is uncertain since it depends, typically, on uncertain end-user printer equipment details. Frequently, for example, the user has no idea what make or model of printer he or she is dealing with.

Another prior art attempt at solving printer problems has resulted in “control panels” on the printer itself. These control panels attempt to provide useful information in dealing with printer functioning issues. Unfortunately the control panels are rudimentary at best and are extremely limited in capabilities.

Repair service providers offer the best printer functioning capability but at the highest cost. However, even printer repair service providers are not perfect. In fact, service provider equipment and training vary so widely that service providers do not see particular printers enough to become experts. Thus, repair service providers, while seemingly most likely to succeed, often have poor repair records since the repair service cannot train enough service providers to ensure that they gain the experience necessary to deal with the wide variety of printers in the marketplace.

Thus, there is a need in the art for providing an apparatus and method for helping a user trouble shoot printer functioning issues that avoids the use of outdated troubleshooting information in manuals or the limited display capabilities of current printers or undertrained technicians.

### SUMMARY OF THE INVENTION

Accordingly, the printer help apparatus and method of the present invention includes, a printer and a supplemental audio/video device, conformed to display audio/visual information concerning the functioning of the printer, the supplemental audio/video device being connected to the printer. In another aspect of the invention the invention includes, in a computer system of networked computers and printers, a help apparatus including at least one computer. A network is connected to the at least one computer and a printer is connected to the network and thereby to the at least one computer. A supplemental audio/video control device conformed to display audio/visual information concerning the functioning of the printer is connected to the printer at the printer site.

In other aspects of the invention, the supplemental audio/video device is conformed to display prerecorded videos, to receive dynamic content for display and to conduct video conferences. In a further aspect of the invention, more than one computer is connected to the network. In other aspects of the invention, the network includes an intranet network and the Internet network. In another aspect of the invention, more than one printer is connected to the network.

In another preferred embodiment of the invention, in a computer system of a plurality of networked computers and at least one distributed printer, a supplemental help apparatus for assisting in the operation of the at least one printer includes a plurality of computers connected to an intranet network. At least one distributed printer is connected to the intranet network and a supplemental audio/visual control device for displaying audio/visual information concerning the functioning of the distributed printer is connected to the printer at the printer location.

In another preferred embodiment of the invention, a method of controlling the functioning of at least one distributed printer is provided by connecting the at least one distributed printer to a supplemental audio/visual control device for displaying audio/visual information concerning the functioning of the distributed printer at the printer location. Next, printer functioning information is received by the supplemental audio/visual control device from the at least one distributed printer and that functioning information is provided to a user at the distributed printer by means of the supplemental audio/visual control device with the user given a selection of audio/visual information from which to choose in responding to the functioning information.

In still another preferred embodiment of the invention, a computer program product for providing user help in the functioning of a distributed printer includes instructions for a supplemental audio/visual control, connected to the distributed printer at the distributed printer location, such that the supplemental audio/visual control is conformed to display audio/visual information concerning the functioning of the distributed printer. In another aspect of the invention, the computer program product includes instructions for conforming the supplemental audio/visual control such that the supplemental audio/visual control is conformed to display prerecorded videos, to receive dynamic content for display and to conduct video conferences.

### DESCRIPTION OF THE DRAWINGS

Other objects, features, and advantages of the present invention will become more fully apparent from the following detailed description of the preferred embodiment, the appended claims and the accompanying drawings in which:

FIG. 1 is a schematic diagram of the printer help apparatus of the present invention;

FIG. 2 is an illustration of the help screen of the present invention offering a written explanation of a printer functioning issue;

FIG. 3 is an illustration of the help screen of the present invention offering a video explanation of a printer functioning issue; and

FIG. 4 is an illustration of the help screen of the present invention offering to initiate a video conference with a certified printer technician to assist with a printer functioning issue.

### DETAILED DESCRIPTION OF THE INVENTION

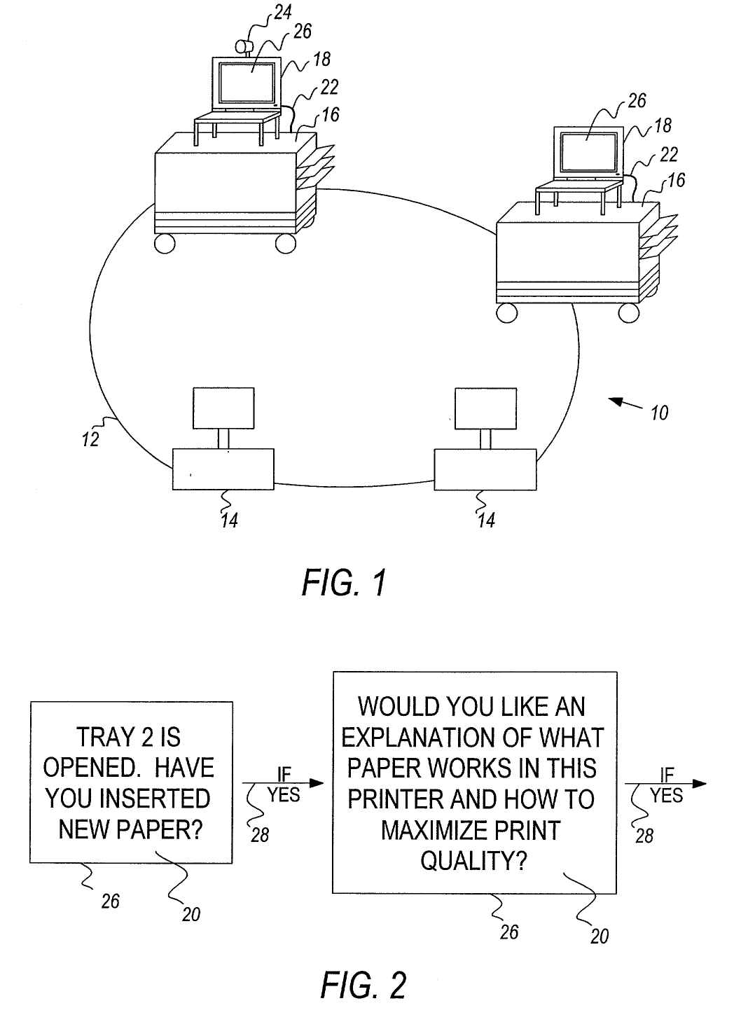

The preferred embodiment of the present invention is illustrated by way of example in FIGS. 1-4. With specific reference to FIG. 1, the printer help apparatus 10 of the present invention includes a network 12, computers 14 and printers 16. Supplemental audio/video control 18 is connected to printers 16 at the physical location of printers 16. Supplemental audio/video control 18 is conformed to display audio/visual information 20 as illustrated by way of example in FIGS. 2-4. Supplemental audio/video control 18 is any supplemental control panel now known are hereafter developed. For example, in a preferred embodiment, Hewlett-Packard's Journada brand handheld pocket PC functions as supplemental audio/video control 18. Supplemental audio/visual control 18 is connected by connection 22 to printer 16. Connection 22 may be any connection now known such as a wireless connection in the nature of the Blue Tooth wireless system, through a USB connection, through a parallel (IEE 1294) connection or through any other connection hereafter developed. Whatever supplemental audio/visual control 18 is selected, it must be fully audio/visual enabled. That is to say, it must provide audio as well as video feedback to users desiring printer help through the printer help apparatus 10 of the present invention. More particularly, supplemental audio/visual control 18 requires outputs in the form of a video screen(s), as discussed hereafter, and speakers, as are known in the art. Further inputs are required such as microphones, keyboards or a touch screen, as are also all known in the art.

In a preferred embodiment, supplemental audio/visual control 18 is conformed to display prerecorded videos. Printers often come these days with information about printer functioning on a CD. The CDs often include video helps. In this embodiment, again, supplemental audio/visual control 18 is designed to display, that is play, these prerecorded “videos” for a user's information and assistance. Certainly any other type of video is contemplated within the scope of the invention including tapes and downloaded “videos” from the Internet or intranet, as will be discussed more fully hereafter. In general, information may be preloaded or dynamically updated on the internal printer disk drive. Further, the updates can be asynchronous to user queries in order to reduce wait times.

In another preferred embodiment of the invention, supplemental audio/visual control 18 is conformed to receive dynamic content and display it. In this embodiment, a user initiates a query to a printer Tech provider in the nature of an e-mail, for example. The dynamic response is received at supplemental audio/visual control 18 which, in accordance with the present invention, is in direct proximity with the printer 16 with which the user is having a functioning problem. One important advantage of the present invention is the increased capability of interaction that is provided by means of supplemental audio/visual control 18 since it is in fact located directly next to the subject printer 16 with a problem. As a result, the dynamic responses, that is responses that are up-to-date, current and timely, as in an instant message response, help short circuit antiquated printed manuals and misguided information concerning misidentified remote printers 16. It should be noted that the printer 16 already has dynamic information generating capability. The supplemental audio/visual control 18 is, however, configured to carry on a “machine to machine” dialog using XML, PML, JVM, SMTP or other suitable protocol.

In another aspect of the invention, supplemental audio/visual control 18 is conformed to conduct video conferences, as are known in the art. Here, the highest level of Tech support is provided a user by means of a direct audio/visual connection with support personnel. In this embodiment, video device 24 is connected to supplemental audio/visual control 18 for the transmission of video images of the user to the Tech personnel and vice versa. Video device 24 is any video device now known or hereafter developed for use in such a manner.

In a further preferred embodiment, supplemental audio/visual control 18 is conformed to display prerecorded videos, to receive dynamic content for display and to conduct video conferences, all as described above.

As illustrated in FIG. 1, in a further aspect of the invention more than one computer 14 is connected to network 12. Computer 14 operates in the typical office environment as the data processor for creating print jobs for printer 16. Multiple computers 14 may be connected to a single printer 16 or multiple computers 14 may be connected to multiple printer 16. In a further aspect of the invention, network 12 may be any network now known are hereafter developed including a common intranet network used in businesses as well as the Internet network. Any network 12 now known or hereafter developed, including wireless, is well within the scope of the invention.

In a situation where, as described, computers 14 are connected by means a network 12 to printers 16, it is most common that printers 16 are remote from computers 14 and are, in fact, distributed throughout the business as best suits the business needs. These “distributed” printers 16 result in a user of computer 14 being separated by some distance from printer 16. Thus, when a printer functioning issue arises, the user typically finds himself or herself in front of the printer with no more help in assessing the functioning issue than an outdated printed manual or a cryptic tiny LCD screen on the printer itself. Printer help apparatus 10 provides a cost-effective efficient set of solution options, including prerecorded video instructions, dynamic technical instructions, and even live face-to-face interface with a human technician skilled in the art of the exact printer 16 in question.

In its simplest form, the present invention includes printer 16 and audio/visual control 18 connected to the printer 16 with preloaded content on the audio/visual control 18 and/or printer 16. Again, content includes, but is not limited to, pre-recorded videos, dynamic content (push model), dynamic content on demand (pull model) and video conferencing. In this form, the invention is suitable for use in walk up printing (copying) environments to guide printer or payment usage/sales. Further, supplemental audio/visual device 18 may be logically connected to the printer 16 through a network card and network 12, for example, while remaining physically co-located. Referring now to FIGS. 2-4, FIG. 2 illustrates the help screen 26 of supplemental audio/visual control 18. In FIG. 2, audio/visual information 20 is displayed on help screen 26 of supplemental audio/visual control 18. Obviously, any information may be so displayed. In FIG. 2, the display begins with the question “Tray two is opened. Have you inserted new paper?” Thereafter additional information may be provided the user. In FIG. 2, the “if yes” arrow 28 leads a user to the next help screen 26 wherein additional information is provided a user. In this case, the question asked is “Would you like an explanation of what paper works in this printer and how to maximize print quality?” Multiple additional if yes arrows 28 are envisioned within the scope of the invention.

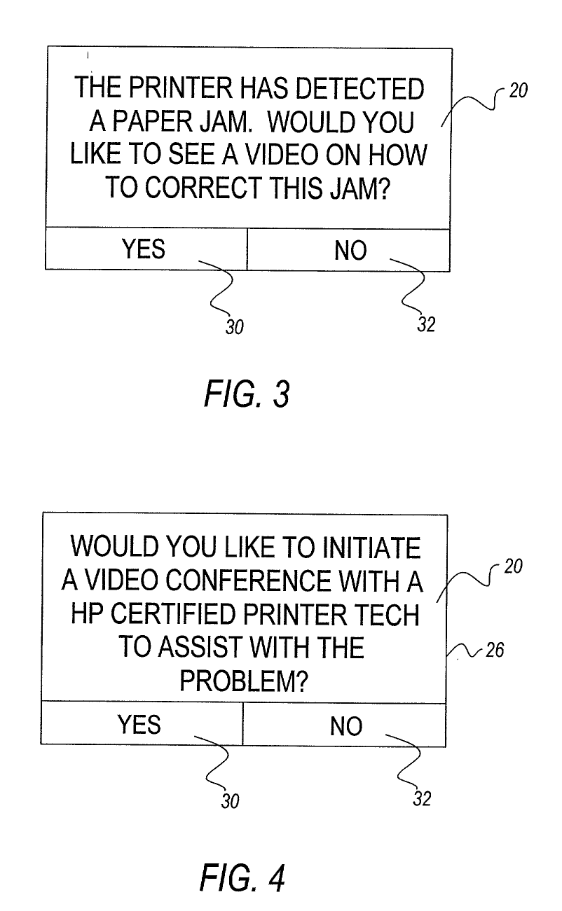

Referring now to FIG. 3, audio/visual information 20 is presented on help screen 26 in another aspect of the invention wherein the user can simply activate a “yes” command 30 or a “no” command 32 in response to a query such as “The printer has detected a paper jam. Would you like to see a video on how to correct this jam?” In a further aspect of the invention, referring now to FIG. 4, supplemental audio/visual control 18 prompts a user by way of help screen 26 with audio/visual information queries to initiate a telephone video conference by way of video device 24. For example, help screen 26, in FIG. 4, states “Would you like to initiate a video conference with a Hewlett-Packard certified printer technician to assist with the problem?”

In operation, a user of printer help apparatus 10 finds its most common application in a computer system of networked computers 14 and at least one distributed printer 16. Computers 14 and printer(s) 16 are connected by network 12. The supplemental audio/visual control 18 is connected directly to printer 16. By directly, it is meant at the physical location of printer(s) 16 is such that the user facing printer functioning problems will be positioned directly in front of supplemental audio/visual control 18 where it is needed. In any instance where a printer malfunctions, the functioning problem is displayed on help screen 26 in the form of audio/visual information 20. Thereafter, a user simply selects the audio/visual information 20 that is appropriate for resolving the printer functioning issue at hand. Such printer functioning issues may be resolved by resorting to an animated video either prerecorded, newly downloaded or real-time, or to real-time instant messaging between the user and a printer technician, or through direct audio visual video conferencing with a qualified technician.

The description of the present embodiments of the invention have been presented for purposes of illustration but are not intended to be exhaustive or to limit the invention to the form disclosed. Many modifications and variations will be apparent to those of ordinary skill in the art. As such, while the present invention has been disclosed in connection with the preferred embodiment thereof, it should be understood that there may be other embodiments which fall within the spirit and scope of the invention as defined by the following claims.

What is claimed is:

1. In a computer system of networked computer(s) and printer(s), a help apparatus for printers, the help apparatus comprising:
a) a printer; and
b) a supplemental audio/video control device conformed to display audio/visual information concerning the functioning of said printer connected to said printer at said printer.

2. The apparatus of claim 1 wherein element b) is conformed to display prerecorded videos.

3. The apparatus of claim 1 wherein element b) is conformed to receive dynamic content for display.

4. The apparatus of claim 1 wherein element b) is conformed to conduct video conferences.

5. The apparatus of claim 1 wherein element b) is conformed to display prerecorded videos, to receive dynamic content for display and to conduct video conferences.

6. The apparatus of claim 1 further comprising at least one computer connected to said printer by a network.

7. The apparatus of claim 6 wherein said network comprises the Internet network.

8. The apparatus of claim 6 wherein said network comprises an intranet network.

9. The apparatus of claim 1 wherein element a) comprises more than one printer.

10. In a computer system of a plurality of networked computers and at least one distributed printer, a supplemental help apparatus for assisting in the operation of said at least one printer, the apparatus comprising:
a) a plurality of computers;
b) a network connected to said computers;
c) at least one distributed printer connected to said network; and
d) a supplemental audio/visual control means for displaying audio/visual information concerning the functioning of said at least one distributed printer connected to said at least one distributed printer at said at least one distributed printer.

11. The apparatus of claim 10 wherein element b) comprises the Internet network.

12. The apparatus of claim 10 wherein element c) comprises more than one printer.

13. The apparatus of claim 10 wherein element d) is conformed to play prerecorded videos, to receive dynamic content for display, and to conduct video conferences.

14. In a computer system of networked computers and at least one distributed printer, a method of controlling the functioning of the at least one distributed printer, the method comprising the steps of:
a) providing at least one distributed printer;
b) connecting a supplemental audio/visual control means for displaying audio/visual information concerning the functioning of said at least one distributed printer to said at least one distributed printer at said at least one distributed printer;
c) receiving functioning information by said supplemental audio/visual control means from said at least one distributed printer concerning the functioning of said at least one distributed printer; and
d) providing a user of said at least one distributed printer, by said supplemental audio/visual control means, with a selection of audio/visual information from which to choose in responding to said functioning information.

15. The method of claim 14 further comprising the step of connecting said distributed printer to a network.

16. The method of claim 15 wherein the step of connecting to a network comprises the step of connecting to the Internet network.

17. The method of claim 14 wherein step a) comprises the step of connecting more than one distributed printer to the network.

18. The method of claim 14 wherein step b) further comprises the step of conforming said supplemental audio/visual control means to display prerecorded videos, to receive dynamic content for display and to conduct video conferences.

19. In a system of at least one distributed printer, a computer program product for providing user help in the functioning of said at least one distributed printer, the computer program product comprising:
a) instructions for a supplemental audio/visual control, connected to said at least one distributed printer at said at least one distributed printer, such that said supplemental audio/visual control is conformed to display audio/visual information concerning the functioning of said at least one distributed printer.

20. The computer program product of claim 19 further comprising instructions for said supplemental audio/visual control such that said supplemental audio/visual control is conformed to display prerecorded videos, to receive dynamic content for display and to conduct video conferences.
